(19) United States
(12) Patent Application Publication
(10) Pub. No.: US 2012/0067727 A1
(43) Pub. Date: Mar. 22, 2012

(54) Apparatus for Preventing Scaling and Removing Scale

(75) Inventors: Steve Thompson, Brookvale (AU); Robyn Anne Fayle, Brookvale (AU)

(73) Assignee: Calclear Investments Pty Ltd., Brookvale (AU)

(21) Appl. No.: 13/072,105

(22) Filed: Mar. 25, 2011

(30) Foreign Application Priority Data
Mar. 25, 2010 (AU) 2010 901268

(51) Int. Cl. B01J 8/16; B01J 19/08

(52) U.S. Cl. 204/661

(57) ABSTRACT

The present invention relates to an apparatus for preventing scaling and/or removing scale in a housing defining a hydraulic environment. The apparatus includes a non-metallic element, at least two coils wound around the element, and a control means. The non-metallic element is retrofittable or incorporable into the housing. The control means is operably coupled to the coils for provision of a magnetic field. The control means includes a microcontroller adapted to cooperate with a switching amplifier to form a closed loop for generation of the magnetic field of a predetermined strength.

### TECHNICAL FIELD

This invention broadly relates to an apparatus for preventing scaling and/or removing scale. The invention particularly relates to an apparatus adapted to generate an electromagnetic field for preventing scaling and/or removing scale in a hydraulic environment.

### BACKGROUND OF THE INVENTION

It is generally desirable in the mining industry to prevent scale forming and building inside a water pipe. For instance, supernatant liquid (SNL) is principally a dilute caustic solution being a waste product generated by an Aluminum refining process. SNL is commonly utilized for a gland fluid and carries a high content of minerals that often cause scaling inside SNL gland water piping.

Apart from chemical-based systems, previous attempts have been made to prevent scaling or remove scale in water treatment by the use of magnetic or electrostatic fields. Magnetic technologies are not effective when silica, iron or other magnetic minerals are present in the system. For this reason, electromagnetic treatment systems have been built to treat mineralized bore or wastewater containing particles of varying size.

The principle on which the electromagnetic treatment systems operate is based relates to breaking up of molecules of mineral salts in a solution so that they cannot accumulate into a damaging scale in hydraulic systems. It has been observed that minerals in a solution that passes through an alternating magnetic field can resonate in sympathy with that field and that when passing through a sudden phase reversal of the same field will fragment, thereby preventing their accumulation into scale.

Conventionally, the electromagnetic treatment systems involve use of sensing antennas to determine the resonant frequencies of the particular water under treatment and only these frequencies are implemented in the phrase reversing alternating magnetic field. These systems however have shortcomings in that extra cumbersome antennas are required. Also, these systems involve the use of a voltage amplifier, or otherwise referred to as a Class A-B amplifier, driving the load coil through resistors to mediate the current through the coil. This poses significant waste heat removal problems and incurs significant costs associated with inclusion of expensive heat sinks.

It is an object of the present invention to provide an apparatus that overcomes or ameliorates the above shortcomings, or that at least provides a useful alternative.

### SUMMARY OF THE INVENTION

An apparatus for preventing scaling and/or removing scale in a housing defining a hydraulic environment, the apparatus includes:

a non-metallic element retrofittable or incorporable into the housing;

at least two coils wound around the element; and

a control means operably coupled to the coils for provision of a magnetic field;

wherein the control means includes a microcontroller adapted to cooperate with a switching amplifier to form a closed loop for generation of the magnetic field of a predetermined strength.

Preferably, the closed loop functions as a current amplifier generating a flow of current through the coils to create the magnetic field.

In a preferred embodiment, the housing includes a metallic pipe adapted to carry a fluid containing minerals that cause scaling. For instance, the fluid may be an industrially treated or recycled liquid or solution that is heavily mineralized.

Preferably, the non-metallic element is adapted to replace a cut-out section of the metallic pipe. More preferably, the non-metallic element includes a plastic pipe section adapted to communicate with the metallic pipe after installation. Even more preferably, the non-metallic element includes a shell adapted to facilitate connection between the non-metallic element and the metallic pipe.

The shell is preferred to encircle the plastic pipe section and include locking means adapted to secure the plastic pipe section to a corresponding part of the metallic pipe. It is also preferred that the shell includes spacers such as one or more donut-shaped O-rings to hold the plastic pipe section in place within the shell and prevent leakage of the fluid.

The control means is preferably contained in an enclosure. The enclosure preferably is detachably mounted onto the shell.

In a preferred embodiment, the microcontroller is programmed to generate a digital signal at a high frequency to the switching amplifier. Preferably, the digital signal is a pulse width modulation (PWM) signal. The microcontroller is preferred to include a processing unit such as a CPU, a non-volatile storage means (such as FLASH) for program and variables, and a means (such as SRAM) for storage of dynamic data during operation. The microcontroller also preferably includes a counter for digital signal generation and an analogue to digital converter for measurement of load currents. Furthermore, the microcontroller is also preferred to include a UART adapted to serially communicate with an external device such as a computer.

The microcontroller is preferably connected to a LED adapted to be activated by the digital signal generated by the microcontroller. The LED may be adapted to indicate operational status and/or conditions of the apparatus.

Preferably, the switching amplifier is a class D amplifier including a bi-directional push-pull digital drive circuit adapted to be driven by the PWM digital signal generated by the microcontroller. The digital drive circuit may be generally referred to as an H-bridge having a power or ground leg with a sense resistor. It is preferred that the sense resistor is a low value resistor adapted to detect an amplitude of the current flowing through the coils. Optionally, two closed loop amplifiers are provided to drive two independent apparatus.

In this embodiment, the apparatus is adapted to create an output signal including an analogue signal. The analogue signal may include a sinusoid or square wave. The analogue signal preferably is monitored by the microcontroller in the closed loop via the sense resistor. The microcontroller may be programmed to adjust the analogue signal according to the detected current amplitude to generate a desired current amplitude that corresponds to the predetermined magnetic field strength.

Furthermore, the frequency of the analogue signal may be continually adjusted by the microcontroller so as to achieve a frequency sweep between substantially 100 Hz to 5 KHz.

It is preferred that the closed loop also includes a filtering means connected between the H-bridge and the load coils. The output signal from the H-bridge may also include high voltage digital signals coherent with the PWM digital signal generated by the microcontroller. The filtering means may be adapted to remove one or more high frequency components (such as a high frequency EMI component) from the output signal thereby leaving a baseband audio component as required by the apparatus.

In a preferred embodiment, one of the two coils is adapted to establish a magnetic field of one polarity whilst the other coil establishes a field of an opposite polarity.

Optionally, a plurality of coils may be used to establish or enhance a desired magnetic field when the liquid is flowing at a high velocity, for example, when the metallic pipe is a narrow gauge pipe. The coils may include windings that are reversible to achieve reversal of the field.

In practice, the coils may have a variable load-impedance, depending upon the type and length of the windings and/or a load inductance. The closed loop control means may vary a drive voltage according to the load impedance thereby maintaining the current at the desired amplitude and correspondingly the magnetic field from the coils at the desired amplitude.

Preferably, the apparatus allows connection to a computer via a serial port and a software interface provided via terminal emulation (such as Hyperterminal on the computer). As such, operating parameters may be displayed to a user of the apparatus. Conveniently, the operating parameters such as the desired current may be set via the software interface.

The apparatus preferably is pre-assembled and transported to a desired site for installation. The coiled non-metallic element, after being connected to the housing, may be installed underground so as to enhance security and minimize interference thereby enhancing performance stability.

The invention may be better understood from the following non-limiting description of the present invention.

### BRIEF DESCRIPTION OF THE DRAWINGS

FIG. 1 is a perspective view of an apparatus in accordance with a preferred embodiment of the present invention.

FIG. 2 is a front view of the apparatus of FIG. 1.

FIG. 3 is a plan view of the apparatus of FIG. 1.

FIG. 4 is an end view of the apparatus of FIG. 1.

FIG. 5 is a cross sectional view of the apparatus of FIG. 2 taken along A-A.

FIG. 6 is a cross sectional view of the apparatus of FIG. 5 taken along B-B.

FIG. 7 is a schematic diagram illustrating the algorithm of a control means of the apparatus of FIG. 1; and

FIG. 8 is a schematic diagram showing an apparatus in accordance with another embodiment of the present invention with six coils installed underground.

### DETAILED DESCRIPTION OF THE INVENTION

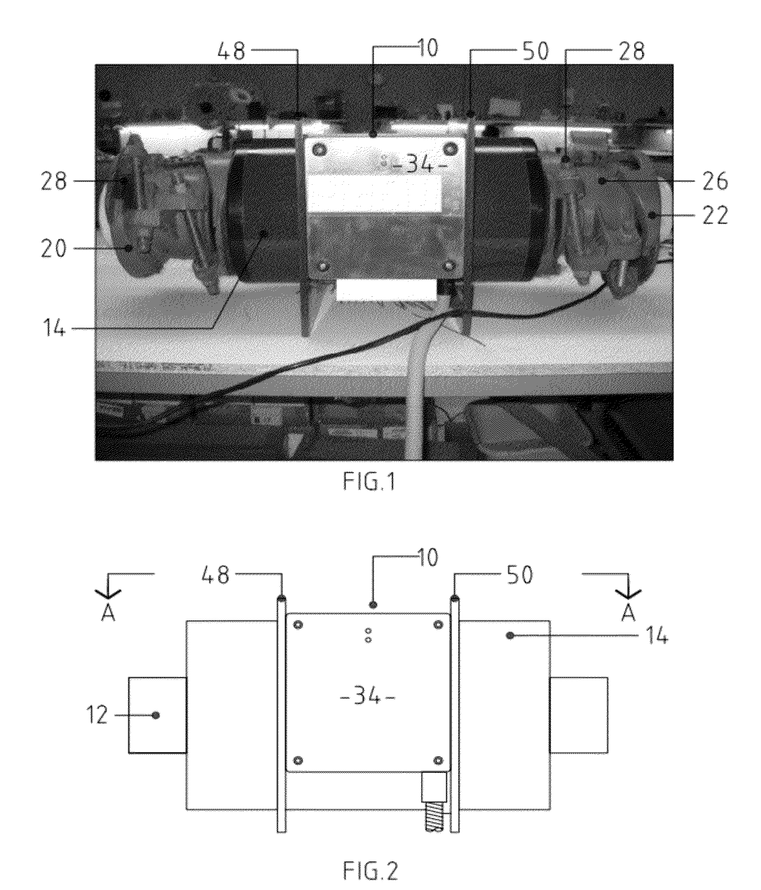

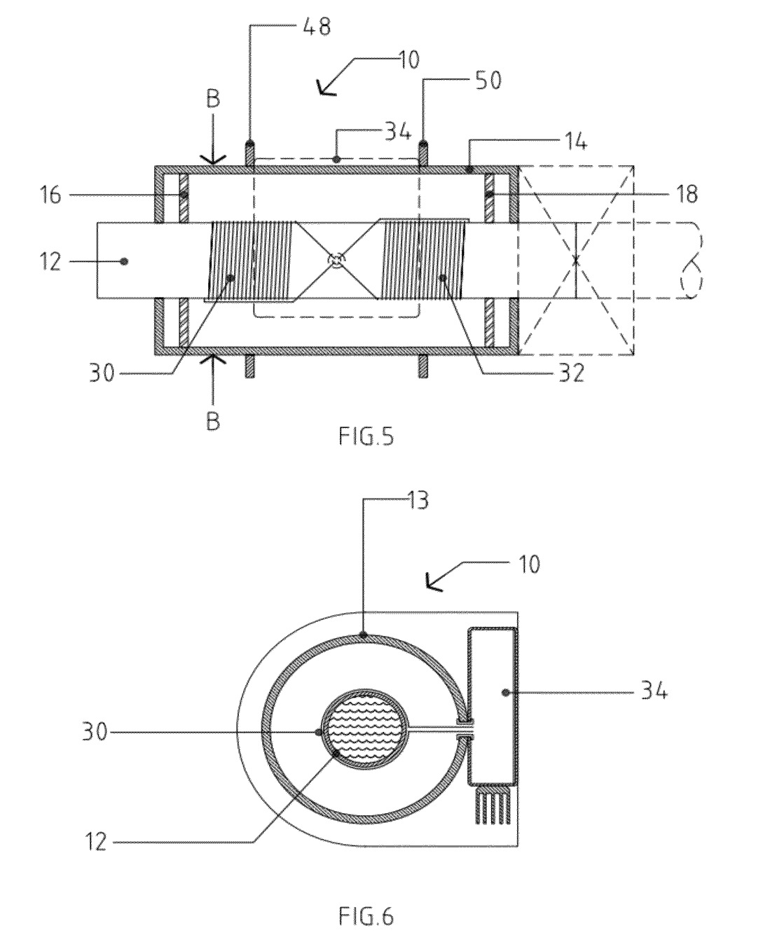

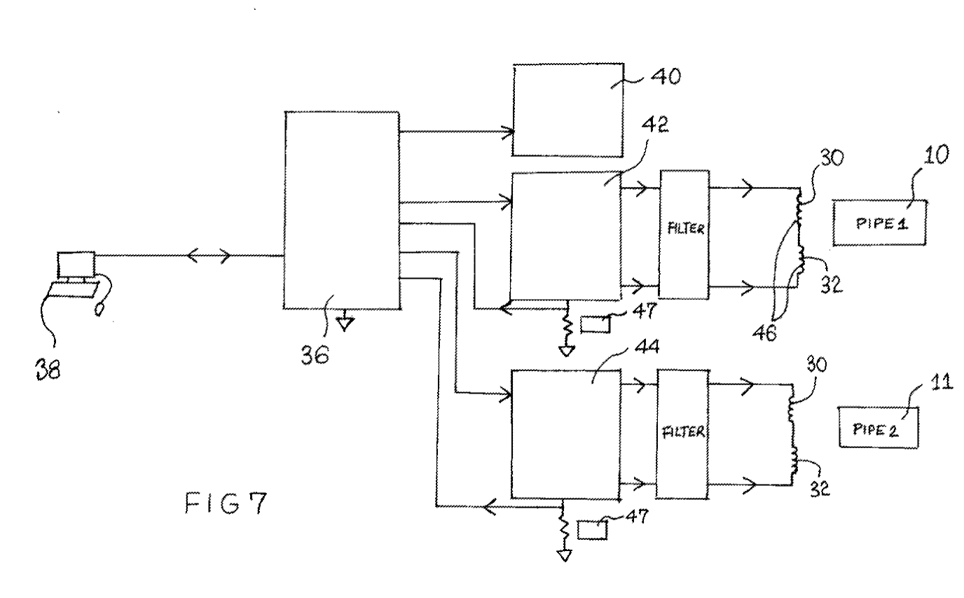

Referring to FIGS. 1 to 6, an apparatus 10 for preventing scaling and/or removing scale in a housing (not shown) defining a hydraulic environment is shown. Although not shown in the drawings, the housing in this embodiment is a metallic pipe configured to carry an industrially treated or recycled liquid or solution that is heavily mineralized. The apparatus of the present invention, however, may be applied to other containers including conduits or tanks used to carry any fluid with a high content of minerals that can cause scaling such as hard water.

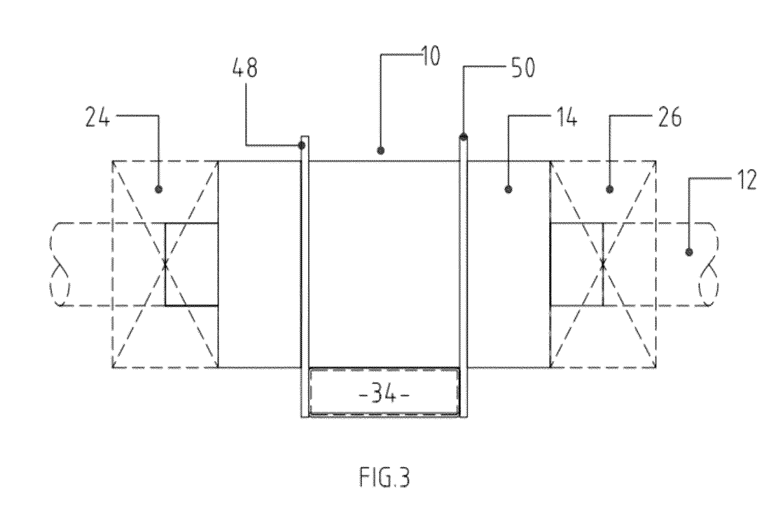

The apparatus 10 includes a non-metallic element in the form of a plastic pipe section 12 that replaces a cut-out section of the metallic pipe. The plastic pipe section 12 is configured such that it is retrofittable or incorporable into the metallic pipe. Once installed, opposing ends of the plastic pipe section 12 adjoin to the respective openings of the metallic pipe such that the plastic pipe section 12 and the metallic pipe are in communication with one another. The plastic pipe section 12 is encircled by a substantially annular shell 13 that facilitates connection between the plastic pipe section 12 to the metallic pipe. Adjacent to the opposing ends of the shell 13 are two spacers 16 & 18 in the form of donut-shaped O-rings. The spacers 16 & 18 function to hold the plastic pipe section 12 in place within the shell 13 thereby preserving coils 30 and 32 and prevent leakage of the liquid or solution in case of an accident. The shell 13 has two couplings 24 & 26 with flanges 20 & 22 located at opposing ends. As best shown in FIGS. 1 and 3, each of the couplings 24, 26 includes locking means 28 for securing the plastic pipe section 12 to a corresponding part of the metallic pipe.

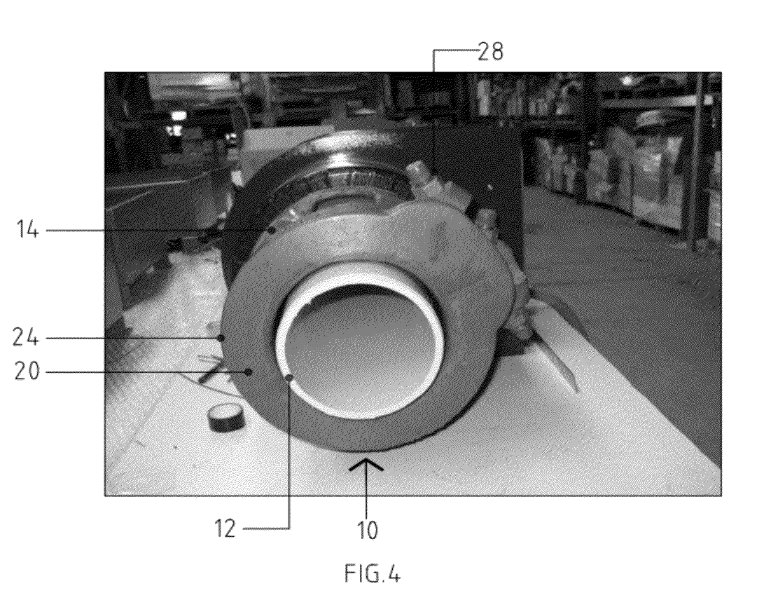

Turning to FIGS. 4 and 5, the apparatus 10 includes two spaced apart coils 30 & 32 that are wound around the plastic pipe section 12. The coils are connected to a control means contained in an enclosure 34 that is detachably mounted onto the shell 14 via two brackets 48 & 50.

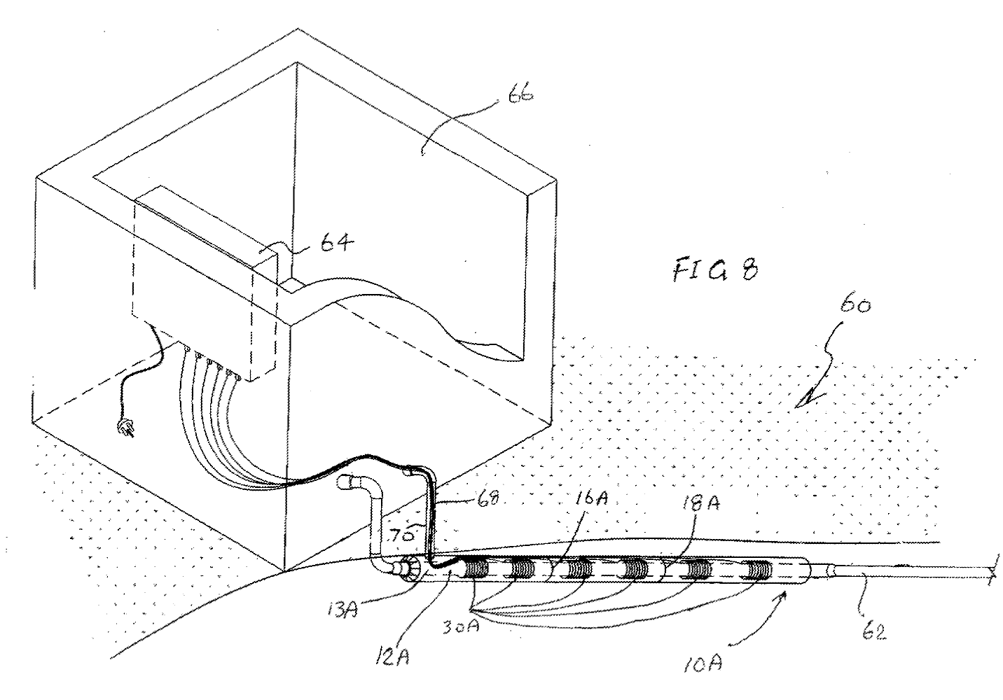

Referring to FIG. 7, the control means has a microcontroller 36 that cooperates with a switching amplifier to form a closed loop for generation of a magnetic field of a predetermined strength via the coils 30 & 32. The closed loop functions as a current amplifier that generates a flow of current through the coils 30 & 32 to create the magnetic field.

The microcontroller 36 is programmed to generate a digital signal at a high frequency to the switching amplifier. The digital signal is a pulse width modulation (PWM) signal. The microcontroller 36 has a processing unit such as a CPU, a non-volatile storage means (such as FLASH) for program and variables, and a means (such as SRAM) for storage of dynamic data during operation. The microcontroller 36 also has a counter for digital signal generation and an analogue to digital converter for measurement of the load current. Furthermore, the microcontroller 36 includes a UART adapted to serially communicate with an external device such as a computer 38. The microcontroller 36 is also connected to a LED 40 that is activated by the digital signal generated by the microcontroller 36. The LED 40 indicates an operational status and conditions of the apparatus 10. The switching amplifier is a class D amplifier including a bi-directional push-pull digital drive circuit driven by the PWM digital signal generated by the microcontroller 36. The digital drive circuit is a H-bridge 42 having a ground or power leg with a sense resistor (not shown). The sense resistor is a low value resistor capable of detecting an amplitude of the current flowing through the coils 30 & 32. As shown in FIG. 7, there are two closed loop amplifiers 42, 44 for driving two independent apparatus 10 & 11.

The microcontroller 36 creates an output signal in the form of an analogue signal. The analogue signal is a sinusoid or square wave that is monitored by the microcontroller 36 in the closed loop via the sense resistor. The microcontroller 36 is programmed to adjust the analogue signal according to the detected current amplitude to generate a desired current that corresponds to the predetermined magnetic field strength.

It should be appreciated that the frequency of the analogue signal may be continually adjusted by the microcontroller 36 so as to achieve a frequency sweep between substantially 100 Hz to 5 KHz.

The closed loop also has a filtering means 44 connected between the H-bridge 42 and the load coils 30 & 32. The output signal from the H-bridge 42 has high voltage digital signals coherent with the PWM digital signal generated by the microcontroller 36. The filtering means 44 functions to remove one or more high frequency components (such as a high frequency EMI component) from the output signal thereby leaving a baseband audio component as required by the apparatus 10.

In order to install the apparatus 10 of the present invention, a section of an existing metallic pipe is to be cut out, dividing the metallic pipe into two halves. The cut-out section is then replaced by the apparatus 10 with its opening ends joined to the opening of the two halves of the metallic pipe respectively via the couplings 24 & 26 and locking means 28.

In operation, one of the two coils 30 or 32 establishes a magnetic field of one polarity whilst the other coil 32 or 30 establishes a field of an opposite polarity. It is contemplated that a plurality of coils may be used to establish or enhance a desired magnetic field when the liquid is flowing at a high velocity, for example, when the metallic pipe is a narrow gauge pipe.

The microcontroller 36 generates a swept frequency signal that in turn drives the audio frequency amplifier. Establishment of the alternating magnetic field is then accomplished by driving the audio frequency amplifier into the coils 30 & 32 wound around the pipe section 12 where the wastewater under treatment is to be passed. Each coil 30, 32 includes windings 46 that are reversible to achieve reversal of the magnetic field. Phase reversal of the field is achieved simply by changing the direction of the windings 46.

It will be appreciated that the switching amplifier (also referred to as switch mode or Class D amplifier) offers great efficiency in the use of available power and hence is particularly useful in situations where minimal power is available, e.g. when solar energy is relied upon. The switching amplifier also ameliorates the problem of waste power (heat) elimination, which is a main concern with a Class A-B amplifier that drives the load coil through resistors to mediate the current through the coil.

It will also be appreciated that the apparatus 10 of the present invention offers a high power efficiency. It should be noted that the significant factor in driving a hydro system coil is electric current (not power). The microcontroller 36 of the apparatus 10 in combination with the switching amplifier effectively function as a current amplifier (as opposed to prior art systems that use a voltage amplifier and resistors to mediate the current). This means that only the power required to establish the current in the drive coil is released by the amplifier. As described above, the microcontroller 36 achieves this by generating the digital D class drive signals directly, monitoring the current and adjusting the drive so that only the desired current is generated. The closed loop design of the present invention is also advantageous in that it automatically adjusts the current to the required level. In prior art systems, the current mediating resistors had to be manually adjusted to set the current in each case, as different systems have different coil and cable lengths. The apparatus 10 requires no load resistors and tuning customization.

It should be noted that the coils 30 & 32 may have a variable load-impedance, depending upon the type and length of the windings 46 and/or a load inductance. The closed loop control means may vary a drive voltage according to the load impedance thereby maintaining the current at the desired amplitude and correspondingly the magnetic field from the coils 30 & 32 at the desired amplitude.

As shown in FIG. 7, the microcontroller 36 of the apparatus 10 is connected to a computer 38 via a serial port and a software interface provided via terminal emulation (such as Hyperterminal on the computer). As such, the operating parameters including the desired current can easily be set via the software interface and a serial communications link to the microcontroller that will retain the parameters in a non-volatile storage such as EEROM. Also, the operating parameters, the operating status and alarm conditions are displayed to a user on the LED 40.

As the load current is a variable under constant scrutiny by the microcontroller 36, fault conditions can be easily detected and alarms can be generated accordingly should a coil go open-circuit, for example.

Referring to FIG. 8, another embodiment of the apparatus 10A is pre-assembled and transported to a site 60 where an irrigation system is installed. The coiled plastic pipe section 12A after being connected to the plastic pipe 62 is installed underground so as to enhance security and minimize interference thereby enhancing performance stability. Being concealed underground, the coiled plastic pipe section 12A is expected to have a prolonged life expectancy. In this embodiment, the apparatus 10A has six coils 30A wound around the plastic pipe section 12A that is joined to the plastic pipe 62 via couplings and locking means in the same manner as described above. The plastic pipe section 12A is encapsulated by a shell 13A and is held in place by spacers 16A & 18A in the form of donut-shaped O-rings. The apparatus 10A is installed underground to replace a cut-out section of the plastic pipe 62 as part of the irrigation system. The coils 30A are connected to a control means 64 that is accommodated in a pump house 66. The portion 68 of the electrical wires connecting the coils 30A to the control means 64 is covered and protected by a sleeve 70.

Now that preferred embodiments of the present invention have been described in some detail, it will be apparent to a person skilled in the art that the apparatus of the present invention may offer at least the following advantages:
it minimizes power requirement by monitoring the output current by the microcontroller and directly adjusting the Class D digital signals to generate only the desired current;
it significantly minimizes power wastage due to heat generation thereby increasing efficiency and eliminating the need for heat sinks;
it enables individual job customization eliminating the need for resistors tuning;
it is capable of detecting and reporting changing and fault conditions in load currents and making automatic adjustments in the field accordingly;
it consumes significantly less power with a high level of efficiency and hence facilitates solar powering in remote communities where minimal power supply is available;
it offers flexibility in that the number of coils may be varied to suit pipes of different sizes;
it is retrofittable into an existing pipe as a pre-assembled module that results in standardized installation and a substantial reduction of onsite labor costs for installation; and
it is suitable for underground installation that minimizes inference, reduces maintenance costs and provide security.

Those skilled in the art will appreciate that the invention described herein is susceptible to variations and modifications other than those specifically described. All such variations and modifications are to be considered within the scope and spirit of the present invention the nature of that is to be determined from the foregoing description.

1. An apparatus for preventing scaling and/or removing scale in a housing defining a hydraulic environment, the apparatus includes:
a non-metallic element retrofittable or incorporable into the housing;
at least two coils wound around the element; and
a control means operably coupled to the coils for provision of a magnetic field;
wherein the control means includes a microcontroller adapted to cooperate with a switching amplifier to form a closed loop for generation of the magnetic field of a predetermined strength.

2. The apparatus of claim 1, wherein the closed loop is configured to function as a current amplifier generating a flow of current through the coils to create the magnetic field.

3. The apparatus of claim 1, wherein the non-metallic element is adapted to replace a cut-out section of the housing.

4. The apparatus of claim 1, wherein the non-metallic element includes a plastic pipe section adapted to communicate with the housing after installation.

5. The apparatus of claim 1, wherein the non-metallic element includes a shell adapted to facilitate connection between the non-metallic element and housing.

6. The apparatus of claim 5, wherein the shell is configured to encircle the plastic pipe section and includes locking means adapted to secure the plastic pipe section to a corresponding part of the housing.

7. The apparatus of claim 5, which also includes one or more spacers encircling the plastic pipe section for holding it in place within the shell.

8. The apparatus of claim 5, wherein the control means is contained in an enclosure detachably mounted onto the shell.

9. The apparatus of claim 1, wherein the microcontroller is programmed to generate a digital signal at a high frequency to the switching amplifier.

10. The apparatus of claim 9, wherein the digital signal is a pulse width modulation (PWM) signal.

11. The apparatus of claim 1, wherein the microcontroller includes a processing unit such as a CPU, a non-volatile storage means (such as FLASH) for program and variables, and a means (such as SRAM) for storage of dynamic data during operation.

12. The apparatus of claim 1, wherein the microcontroller includes a counter for digital signal generation and an analogue to digital converter for measurement of load currents.

13. The apparatus of claim 1, wherein the microcontroller includes a UART adapted to serially communicate with an external device such as a computer.

14. The apparatus of claim 9, wherein the microcontroller is connected to a LED adapted to be activated by the digital signal generated by the microcontroller.

15. The apparatus of claim 14, wherein the LED is adapted to indicate operational status and/or conditions of the apparatus.

16. The apparatus of claim 9, wherein the switching amplifier is a class D amplifier including a bi-directional push-pull digital drive circuit adapted to be driven by the digital signal generated by the microcontroller.

17. The apparatus of claim 16, wherein the digital drive circuit includes an H-bridge having a power or ground leg with a sense resistor.

18. The apparatus of claim 17, wherein the sense resistor is a low value resistor adapted to detect an amplitude of the current flowing through the coils.

19. The apparatus of claim 1, wherein two closed loop amplifiers are provided to drive two independent apparatus.

20. The apparatus of claim 1, which is adapted to create an output signal including an analogue signal.

21. The apparatus of claim 20, wherein the analogue signal includes a sinusoid or square wave.

22. The apparatus of claim 20, wherein the analogue signal is monitored by the microcontroller in the closed loop via the sense resistor.

23. The apparatus of claim 20, wherein the microcontroller is programmed to adjust the analogue signal according to the detected current amplitude to generate a desired current amplitude that corresponds to the predetermined magnetic field strength.

24. The apparatus of claim 20, wherein the frequency of the analogue signal is continually adjusted by the microcontroller so as to achieve a frequency sweep between substantially 100 Hz to 5 KHz.

25. The apparatus of claim 17, wherein the closed loop also includes a filtering means connected between the H-bridge and the load coils.

26. The apparatus of claim 20, wherein the output signal from the H-bridge also includes high voltage digital signals coherent with the digital signal generated by the microcontroller.

27. The apparatus of claim 25, wherein the filtering means is adapted to remove one or more high frequency components from the output signal thereby leaving a baseband audio component as required by the apparatus.

28. The apparatus of claim 1, wherein one of the two coils is adapted to establish a magnetic field of one polarity whilst the other coil establishes a field of an opposite polarity.

29. The apparatus of claim 1, wherein a plurality of coils is used to establish or enhance a desired magnetic field when the liquid is flowing at a high velocity.

30. The apparatus of claim 1, wherein the coils include windings that are reversible to achieve reversal of the field.

31. The apparatus of claim 1, wherein the coils have a variable load-impedance, depending upon the type and length of the windings and/or a load inductance.

32. The apparatus of claim 1, wherein the closed loop control means is capable of varying a drive voltage according to load impedance thereby maintaining the current at the desired amplitude and correspondingly the magnetic field from the coils at the desired amplitude.

33. The apparatus of claim 1, which allows connection to a computer via a serial port and a software interface provided via terminal emulation.

34. The apparatus of claim 1, wherein operating parameters including a desired current is capable of being set via the software interface.

35. The apparatus of claim 1, which is capable of being installed underground so as to enhance security and minimize interference thereby enhancing performance stability.

36. The apparatus of claim 1, wherein the coiled non-metallic element after being connected to the housing is capable of being installed underground.
